(19) United States
(12) Patent Application Publication
(10) Pub. No.: US 2005/0221055 A1
(43) Pub. Date: Oct. 6, 2005

(54) Masking material

(76) Inventors: Masanori Ogawa, Aichi (JP); Kuninori Ito, Aichi (JP)

Correspondence Address: Donald S Dowden;Cooper & Dunham, 1185 Avenue of the Americas, New York, NY, 10036, US

(21) Appl. No.: 10/518,745

(22) PCT Filed: Jun. 2, 2003
(86) PCT No.: PCT/JP03/06967

§ 371 Date: Dec. 9, 2004

(30) Foreign Application Priority Data
Jun. 14, 2002 (JP) 2002-174568

(51) Int. Cl. B32B 3/28

(52) U.S. Cl. 428/167

(57) ABSTRACT

The object of the present invention is to make the boundary between a coated part and uncoated part a straight line in a case where said uncoated part is protected by a masking member during coating. To attain this object, the present invention provides a masking member (11) consisting of a panel (11A) of a foamed polystyrene having an expansion ratio in the range of between 5 and 100 times, wherein grooves (12) are formed at set positions on one side or either side of said panel (11A), dividing it into a plural number of unit blocks, said masking member consisting of one or more of said unit block(s) is snapped from said panel (11A) through said groove(s) (12), the edge of said masking member along the snapping line being substantially straight.

### FIELD OF THE INVENTION

The present invention relates to a masking member used in cases of surface treatment, such as coating, plating, or the like.

### BACKGROUND OF THE INVENTION

For instance, in a case where rust inhibiting paint is coated on the underside of a car, certain areas of the under side, on which parts are fixed or females screw holes are situated, or the like, should be protected from with said paint.

Traditionally, a masking member (31) consisting of a foamed polystyrene panel (31A) wherein grooves (32) are formed crosswise on either side of said panel (31A), dividing it into a plural number of blocks (31B), with an adhesive layer (33) being formed on one side of said panel (31A), has been provided as shown in FIG. 16.

Utility model patent H04-3652

When spray coating is carried out, a prescribed number of said unit block(s) (31B) (for instance 2×2=4 pieces) are(is) snapped from said panel (31A) of said masking member (31) along said groove(s) (32 ) as shown in FIG. 17, after which said masking member (31) consisting of said unit block(s) is(are) attached to a part of an article to be protected through said adhesive layer (33) from coating, said part possibly being a bolt hole (5), on the backside of which a nut (4) is welded. Then, for instance, said article is coated by spraying paint with a spray gun (8), and after coating, said masking member (31) is removed by a hook or the like.

Traditionally, when said masking member (31) is snapped from said panel (31A) along said groove(s) (32), the edge (34) of said masking member (31) along the snapping line becomes serrated, making the boundary L of the coating film F between the uncoated part (3) around the periphery of said bolt hole (5) and the coated part also potentially serrated as shown in FIG. 18. In a case where the boundary L of the uncoated part around the periphery of said bolt hole (5) becomes serrated, when a bolt (7) is screwed into said nut (4) in said bolt hole (5) through a washer (6), as shown in FIG. 19, the edge of said washer (6) and the boundary L of the coating film F are not flush, so that there is a concern that the exposed, uncoated part around the periphery of said washer will rust, causing the unfastening of said bolt, and the deterioration of the appearance.

### DISCLOSURE OF THE INVENTION

To solve aforementioned conventional problem, the present invention provides a masking member (11) consisting of a panel of a foamed polystyrene having an expansion ratio in the range of between 5 and 100 times, wherein grooves are formed at set positions on one side or either side of said panel (11A) dividing it into the plural number of unit blocks (11B).

It is preferable that the depth (d) of each groove (12), in a case where said grooves are formed on one side of said panel, or the sum (d+d) of the depths (d) of a pair of said grooves (12,12) in a case said grooves are reciprocally formed at corresponding positions on either side of said panel, be in the range of between 10 and 70% of the thickness of said panel (D). Further, the width of each groove is preferably in the range of between 1 and 5 mm.

For instance, an adhesive layer (13) is preferably formed on one side of said panel (11A), and inserting parts (24) may be formed on one side of said panel (22A). In such a case, knobs (25) may be further formed on the opposite side of said panel (22A), and ribs (27) may be formed around each inserting part (24) of said panel (22A). In a case where the expansion ratio of the foamed polystyrene composing said masking member (11) is in the range of between 5 and 100 times, more preferably between 10 and 80 times, and ideally between 20 and 60 times, when said masking member (11) is snapped along said groove (12), the edge (15) of said masking member (11) along the snapping line becomes substantially straight. In a case where said masking member (11) having a straight edge (15) along its snapping line is used for masking, the boundary between the coated part and the uncoated part becomes substantially straight.

When depth (d) of each groove (12), in a case where said grooves (12) are formed on one side of said panel (11A), or the sum of the depths (d+d) of a pair of said grooves (12,12), in a case where said grooves are formed reciprocally at corresponding positions on either side of said panel (11A), is set to be in the range of between 10 and 70%, more preferably between 20 and 60%, and ideally between 30 and 50%, the straightness of said boundary is further improved.

### BRIEF DESCRIPTION OF THE DRAWINGS

FIG. 1 relates to an embodiment of the present invention, and shows a perspective view.

FIG. 2 shows a side sectional view to illustrate grooves.

FIG. 3 shows a side view.

FIG. 4 shows a perspective view of an article.

FIG. 5 shows a plan view of a snapped, (2×2 unit blocks) sized masking member.

FIG. 6 shows a perspective view to illustrate the coating process.

FIG. 7 shows a perspective view to illustrate the removal of said masking member after coating.

FIG. 8 shows a perspective view to illustrate the screwing of a bolt into the unit of said bolt hole.

FIG. 9 relates to another embodiment of the present invention, and shows a perspective view of said masking member.

FIG. 10 relates to another embodiment of the present invention, and shows a perspective view of the back side of a unit masking member.

FIG. 11 relates to another embodiment of the present invention, and shows a side sectional view in a case where said unit masking member is inserted in the harness hole of a panel shaped article.

FIG. 12 relates to another embodiment of the present invention, and shows a perspective view of said article after coating.

FIG. 13 relates to another embodiment of the present invention, and shows a perspective view in a case where a plug is inserted into said harness hole.

FIG. 14 relates to a further embodiment, and shows a side view of a unit masking member.

FIG. 15 relates to a still further embodiment, and shows a side view of a unit masking member.

FIG. 16 shows a perspective view of a conventional masking member.

FIG. 17 shows a perspective view to illustrate a case where an article having a bolt hole is coated.

FIG. 18 shows a perspective view of said article after coating.

FIG. 19 shows a perspective view of a conventional case where a bolt is screwed into a bolt hole.

EXPLANATION OF CODES

| | |
|---|---|
| 11, 21 | masking member |
| 11A, 22 | panel |
| 11B, 22 A | unit block |
| 12.23 | groove |
| 24 | inserting part |
| 25 | knob |
| 27 | rib |

### PREFERRED EMBODIMENT

The present invention is described in detail.

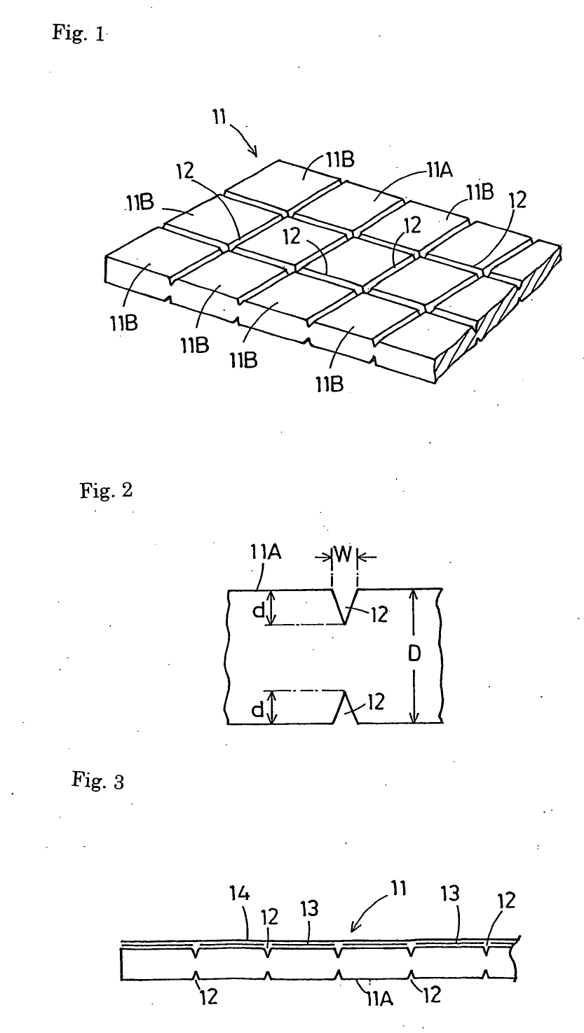

The present invention is described according to the embodiment shown in FIGS. 1 to 8. The masking member (11) shown in FIG. (11A) shows a panel made of a foamed polystyrene having an expansion ratio in the range of between 5 and 100 times, preferably between 10 and 80 times, and ideally between 20 and 60 times. The crosswise grooves (12), being formed at set intervals on both sides of said panel (11A), divide said panel into a plural number of unit blocks (11B).

Said grooves may be formed on one side of said panel (11A) in the present invention. As shown in FIG. 2, the sum of the depths (d+d) of grooves (12,12) formed reciprocally at corresponding positions on either side of said panel (11 A) are preferably set to be in the range of between 10 and 70% of the whole thickness D of said panel (11A), and the depths of said grooves (12,12) formed on either side of said panel (11A) are preferably equal each other. Further, the maximum width W of said groove (12) is set to be in the range of between 0.1 and 5 mm, preferably between 0.5 and 4 mm, and ideally between 1 and 3 mm.

In a case where the depth of said groove (12) is less than said range, said masking member (11) may be difficult to snap, and in a case where the depth of said groove (12) exceeds said range, said masking member (11) is apt to be snapped during carrying or the like. Further, in a case where the width of said groove (12) is less than said range, said masking member (11) will be difficult to snap, and in a case where the width of said groove (12) exceeds said range, the snapped edge(s) of said masking member (11) may suffer dents, and it is feared that paint will intrudes beneath said snapped edge part(s) of said masking member (11).

To manufacture said panel (11A), said panel (11A) is itself molded in a mold, or initially foamed polystyrene block is manufactured, after which said panel (11A) is cut from said block by a heater or the like.

Said groove (12) has a V-shaped cross section or U-shaped cross section and said grooves (12) may be formed at the same time that said panel (11A) is molded or said grooves (12) may be formed by the shaping of said panel (11A) after being cut from the block.

As shown in FIG. 3, an adhesive layer (13) is further formed on one side of said panel (11A), and a release sheet (14) such as a polyethylene film, polypropylene film, release paper, or the like is attached to said adhesive layer (13), so that said masking member (11) can be piled without sticking together, and said masking member (11) can be easily transported or kept, since said adhesive layer (13) of said masking member (11) is covered with said release sheet (14).

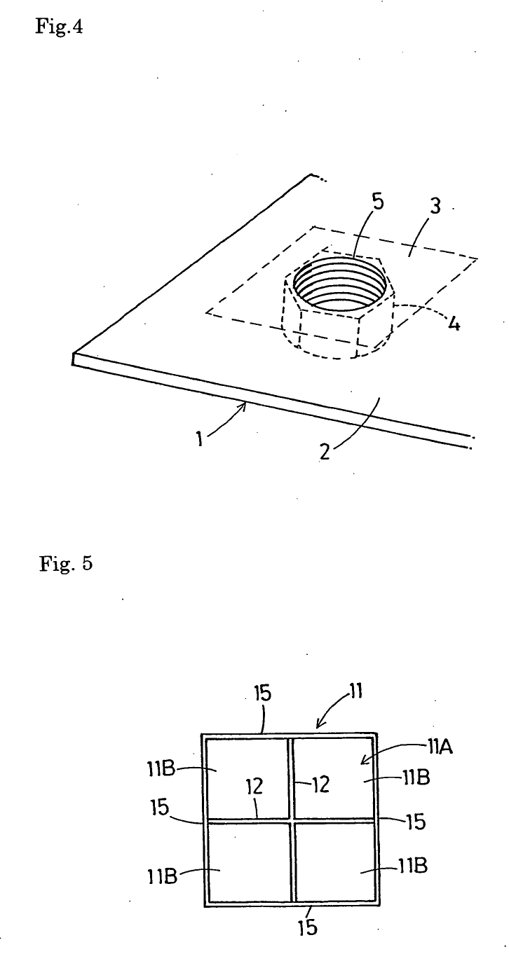

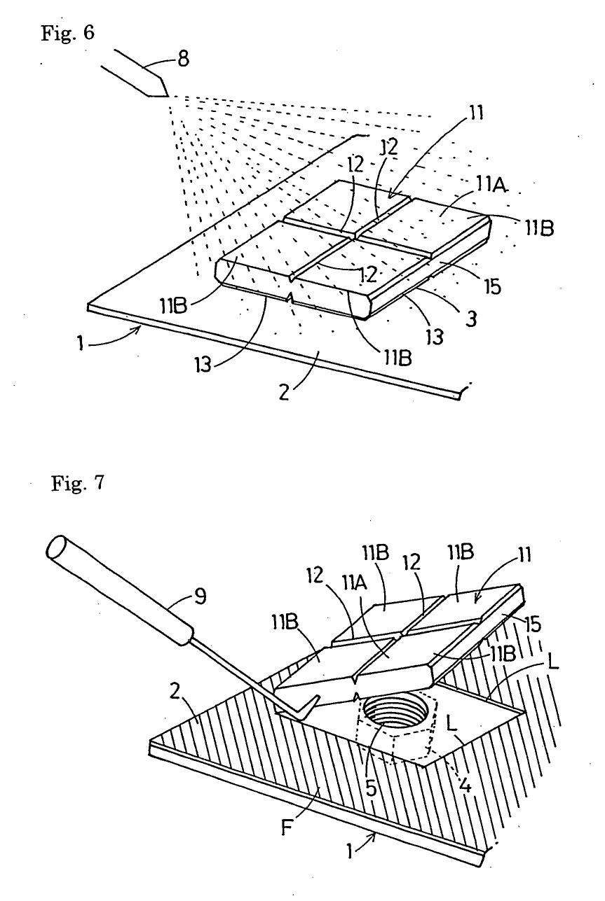

As shown in FIG. 4, said masking member (11) is attached to a part (3) of the surface of an article (1) having a panel shape, where the coating should not be effected, said part (3) surrounding a bolt hole (5) on whose backside, a nut (4) is welded, as shown in FIG. 4. Before attaching said masking member (11) to said part (3), said releasing sheet (14) is peeled away from said masking member (11), after which said masking member (11) is snapped by hand into a set size, corresponding to the size of said part (3), such as in the size (2×2=4 unit blocks (11B)) along said grooves (12) as shown in FIG. 5. Since the expansion ratio of said masking member (11), the depth (d) and the maximum width W of said groove (12) are respectively set to be in the range described above, the edge (15) of said masking member (11) along the snapping line will be straight.

Said masking member (11), being snapped into a set size (2×2), is then attached to said part (3) of the surface (2) of said article (1) to be coated through on adhesive layer, and as shown FIG. 6, a paint spray gun or the like is used to coat said surface (2).

After coating, said masking member (11) is removed from said part (3) by hook (9) or hand before or after the curing of the film F formed, as shown in FIG. 7.

Or said masking member (11) is automatically removed by heating it to a temperature higher than that of the softening point of the plastic of said masking member, thus shrinking said masking member (11).

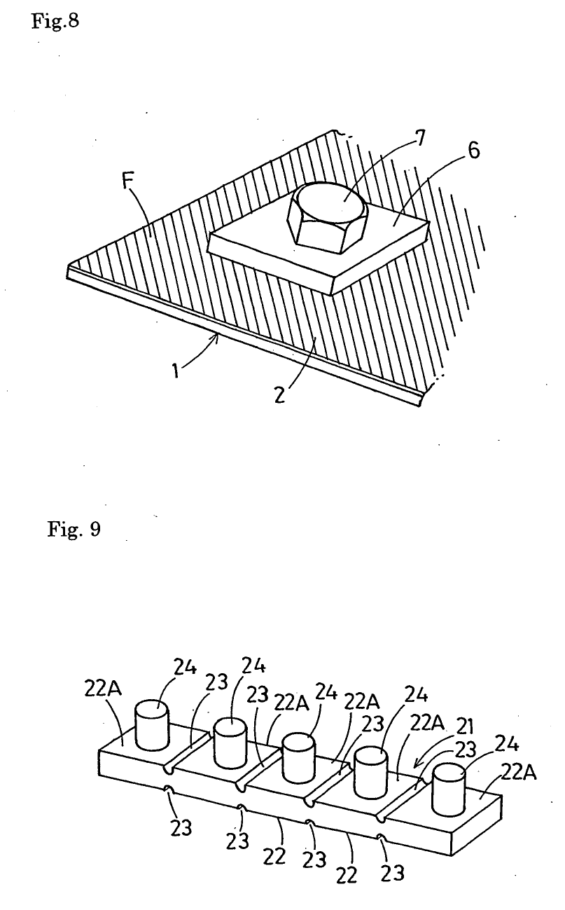

Since said masking member (11) has substantially straight edge(s) (15) along its snapping line, the boundary line L between the coated part and the uncoated part (3) of the surface of said article become(s) substantially straight. Accordingly, when a bolt (7) is screwed into said nut (4) welded on the backside of said bolt hole(s) through a washer (6) as shown in FIG. 8, the edges of said washer (6) and the boundary line L of the coating film surrounding said uncoated part (3) match, so that said uncoated part (3) is not exposed around said washer (6).

FIGS. 9 to 13 relate to another embodiment of the present invention. The masking member (21) of this embodiment consists of a stand base (22) upon which there are a plural number of grooves (23) on either side arranged at regular intervals, dividing it into a plural number of unit blocks (22A), a tapering inserting part (24) protruding from one side of said stand base (22), and a knob (25) protruding from the other side of said stand base (22).

Said masking member (21) is made of a foamed polystyrene having an expansion ratio in the range of between 5 and 100 times, preferably between 10 and 80 times, and ideally between 20 and 60 times, the sum of the depths (d+d) of a pair of grooves (23,23) formed reciprocally at corresponding positions on either side of said stand base (22) is preferably set to be in the range of between 10 and 70% of the whole thickness of said stand base (22), with the maximum width of said grooves (23,23) preferably being set to be in the range of between 0.1 and 5 mm, the same as in the prior embodiment.

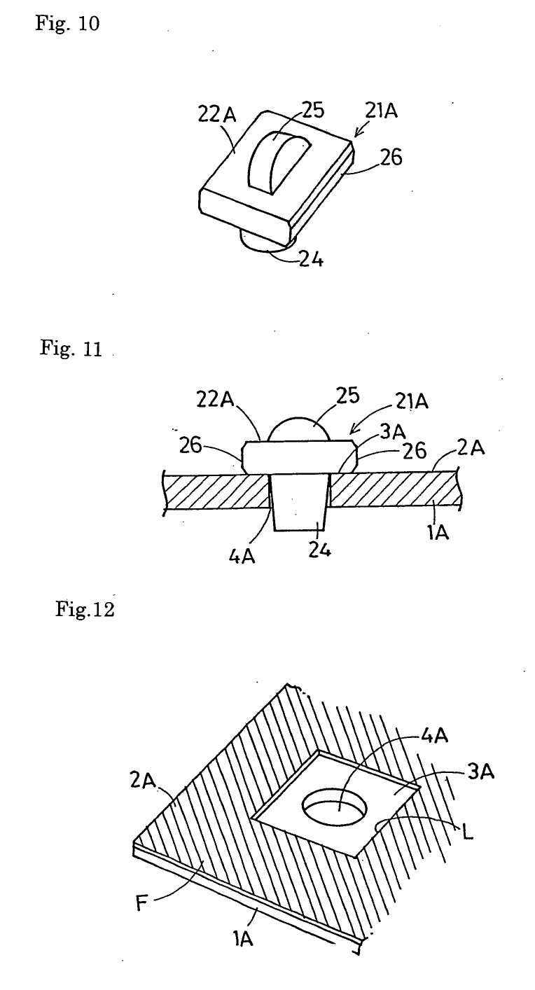

Said stand base (22) is snapped along said groove (23) to be a unit masking member (21A) as shown in FIG. 10, with the edges (26) of said masking member along snapping line being substantially straight.

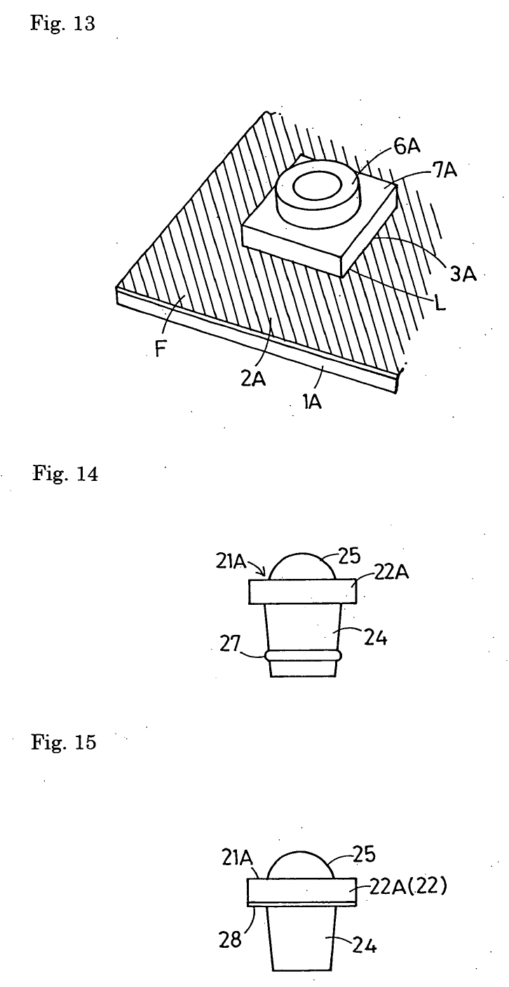

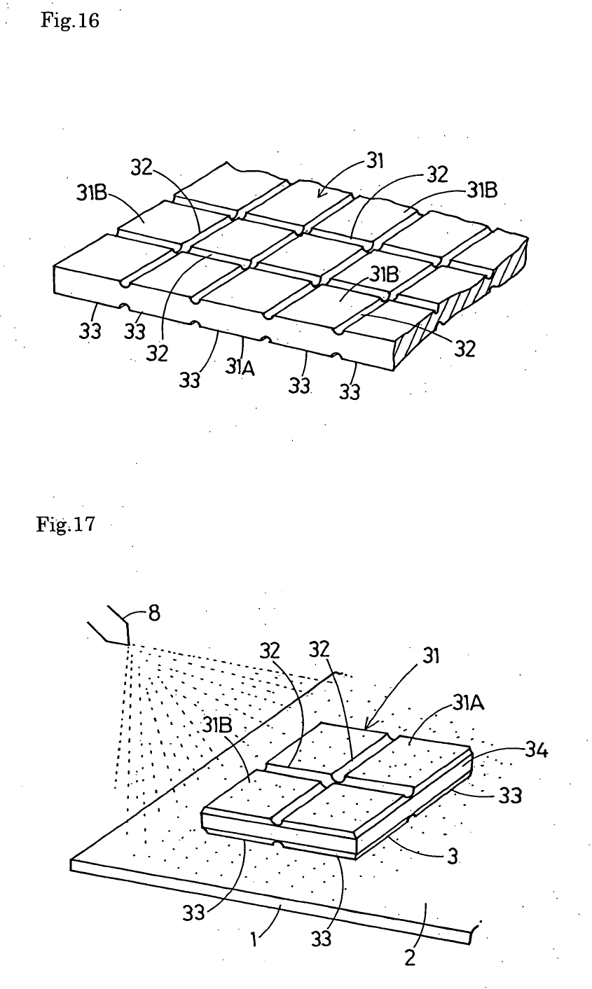

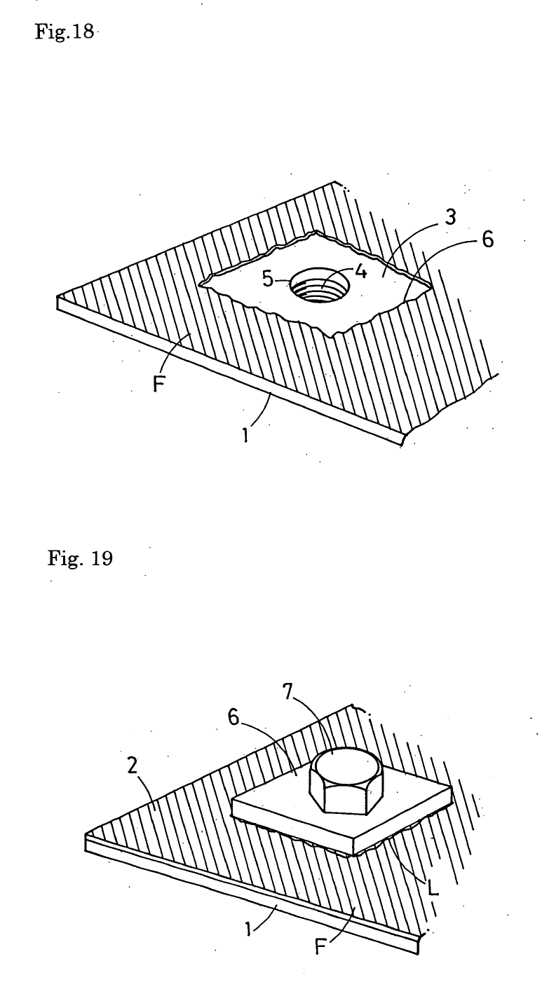

Said unit masking member (21A) which corresponds to said unit block (22A) is snapped along said grooves as described above, and said unit masking member (21A) is attached to the harness hole (4A) of a snapped panel article (1A) by putting said inserting part (24) of said unit masking member (21A) into said harness hole (4A), to protect said harness hole (4A) and its periphery (3A) (uncoated part) as shown in FIG. 11. After coating of the surface of said article to be coated (2A), said unit masking member (21A) is removed from said harness hole (4A). As shown in FIG. 12, the boundary lines L of the coating film F along the edges surrounding said uncoated part (3A) are substantially straight, and the plug (6A) into which said harness(es) is(are) passed through is attached to said harness hole (4A), as shown in FIG. 13. Since the boundary lines L of the coating film F surrounding said uncoated part (3A) are substantially straight, no noticeable gap will be formed between the stand (7A) of said plug (6A) and the boundary line L of the coating film F.

In said masking member (21), a ring rib (27) may be formed around the end of said inserting part (24), said ring rib (27) engaging with said hole (4A), as shown in FIG. 14, and an adhesive layer (28) may be formed on the back side of said stand (22), as shown in FIG. 15.

### INDUSTRIAL UTILITY

In the present invention, both the edge(s) surrounding the uncoated part which has been protected by the masking member, and the boundary line L of the coating film, are substantially straight; in the case when a member such as the washer, the stand, or the like is attached to said uncoated part, no noticeable gap will be formed between said member and the coating film.

1. A masking member made of a foamed polystyrene having an expansion ratio in the range of between 5 and 100 times wherein snapping grooves are formed at set positions on one or either side of said panel, dividing it into a plural number of unit blocks, and in a case where said grooves are formed on one side of said panel, the depth of said grooves is set to be in the range of between 10 and 70% of the thickness of said panel, and in a case where said grooves are formed the sum of the depths of a pair of said grooves reciprocally at corresponding positions on either side of said panel, is set to be in the range of between 10 and 70% of the thickness of said panel.

2. (canceled)

3. A masking member in accordance with claim 1, wherein the width of each groove is in the range of between 1 and 5 mm.

4. A masking member in accordance with claim 1, wherein an adhesive layer is formed on one side of said panel.

5. A making member in accordance with claim 1, wherein inserting parts are formed on one side of said panel.

6. A masking member in accordance with claim 5, wherein knobs are further formed on,the opposite side of said panel.

7. A masking member in accordance with claim 5 or 6, wherein a rib is formed around each inserting part of said panel.

8. A masking member in accordance with claim 6, wherein a rib is formed around each inserting part of said panel.
